(19) United States
(12) Patent Application Publication
(10) Pub. No.: US 2026/0050799 A1
(43) Pub. Date: Feb. 19, 2026

(54) SYSTEM AND METHOD OF CREATING DIGITAL CHARACTERS USING DYNAMIC VALENCE SCORES

(71) Applicant: Janak Babaji ALFORD, Elgin (CA)

(72) Inventor: Janak Babaji ALFORD, Elgin (CA)

(21) Appl. No.: 18/805,643

(22) Filed: Aug. 15, 2024

Related U.S. Application Data
(60) Provisional application No. 63/520,539, filed on Aug. 18, 2023.

(51) Int. Cl. G06N 5/02

(52) U.S. Cl. CPC G06N 5/02

(57) ABSTRACT

The present disclosure provides a system and method for creating digital characters using dynamic valence scores applied to knowledge graphs. The system is comprised of at least a knowledge graph interface to manage nodes and edges, as well as a valence score generator and a valence curve modeller. At any selected point in a character's timeline, the system outputs textual or numeric representations of the positivity and intensity of associations held within the graph. Meanwhile, the method to create a digital character comprises creating the nodes and edges in the graph network interface, applying the curve modeller to generate dynamic valence scores over time, and utilizing a network interrogator to convert the valence scores into textual or numeric representations of the digital character's affective state at a relative point in time.

### CROSS-REFERENCE TO RELATED APPLICATION

The present application claims priority to U.S. Provisional Application No. 63/520,539, entitled “SYSTEM AND METHOD OF CREATING DIGITAL CHARACTERS USING DYNAMIC VALENCE SCORES” filed on Aug. 18, 2023, the contents of which are incorporated herein by reference in their entirety.

### FIELD

The disclosure relates to the field of synthetic character creation, and more specifically to a system and method to create digital characters possessing dynamically shifting personalities that utilize valence scores applied to knowledge graphs that are interpreted over a timeline.

### BACKGROUND

To date, the representations of characters, be they biographical portrayals of actual persons or fictional portrayals of conceived characters, have exhibited fundamental flaws due to their limited and static depictions of personality, motivation, and emotional depth.

Textual representations of characters in written works are static as limited by the medium and language. Characters in written works are not dynamically interactive. Literary works have limited capacity to accurately describe the large number of subconscious and affective influences informing the actions of their characters. Consequently, writers often resort to employing narrative tools such as archetypes, which serve as simplified stand-ins for more nuanced and intricate character motivations informed by a plurality of experiences and associations. Limited linguistic descriptions of emotional state, such as “happiness” or “anger”, are used as descriptive shorthand to describe complex and often contradictory inner experiences.

Interactive digital characters, such as non-player characters (NPCs) in video games or inhabitants of virtual reality environments, have traditionally been limited by logic-driven programming fixed and storylines. These limitations have led to portrayals of characters that do not fully reflect the depth and dynamism found in actual human interactions or behaviors.

Textual interaction interfaces, commonly referred to as “chatbots”, are often criticized for their inability to authentically emulate human traits such as character nuances, emotional responses, and psychological conditions. These systems, which are commonly based on so-called large language models, have not yet achieved a level of sophistication necessary to convincingly replicate the complexities of human nature in their interactions. These systems may be configured to mimic emotional responses; however, they utilize narrative devices and text-based heuristics to approximate human emotional states. These LLM-based systems do not embody a deep and realistic personality that informs their simulated emotions but rather use probabilistic textual mechanisms derived from source training material.

A new method of character creation and representation is required. A network knowledge graph presents an ideal structure for building a character's life story, including events, activities, interactions, and relationships. A knowledge graph is an information structure that consists of “nodes” and “edges”. Nodes are data points that represent various characteristics or pieces of information about a character or experiences, both tangible and intangible. Edges form relationships between these points, illustrating or describing how they are related to one another. New node and edge features are added or modified as the character develops over its timeline and new events and relationships are recorded. In concert, the nodes and edges may be interpreted by humans and computers alike as a non-linear collection of relationships between entities, concepts, and locations, thus enabling the capture and representation of a biographical set of facts. Two nodes and an edge can represent a common “subject-verb-object” pattern used in language and thus can be similarly understood.

This method utilizing of knowledge graph architecture for character creation is enhanced through the incorporation of so-called “valence scores” into the graph's edge connections. Valence is a measurable index representing the positivity and intensity of emotional associations the character may hold regarding experiences, relationships, locations, people, or interpersonal interactions. This innovation allows each edge within a character's knowledge graph to further represent an affective, or emotional, association to that data point. By embedding this emotional quantification into the graph's structure, a more detailed understanding of an individual's inherent perspectives and emotional responses to specific situations and interactions is achieved. The associations applied to a character's biographical history may be readily interpreted to reveal its likes and dislikes, and the intensity thereof, to inform a deeper insight its biases, interests, and motivations.

The present invention further enhances this approach by applying dynamic valence scores to represent changes in these emotional association at various points along a character's timeline. Sampled at various points in a character's life, the changing positivity and intensity of valence scores may be represented as two-dimensional graphs, depicting a linear or curvilinear trajectories hereafter referred to as “valence curves”. These curves represent the emotional intensity and positivity of associations over time. As an example, the positivity of a character's experience may start out strong but fade with time. Similarly, the intensity of this experience may also decrease. Conversely, a relationship between individuals may adopt the opposite form, increasing in both positivity and intensity through continual enjoyable interactions. These changes may occur linearly or along some curve or other pattern. Further, the rate of change may be gradual or subtle. Thus, the form of the valence curve provides a graphical and numeric representation of the character's emotional and affective state changes over time, offering a more precise and dynamic portrayal than previously possible.

The incorporation of valence curves into the edges of a knowledge graph constitutes a substantial improvement over prior methods of creating or representing synthetic characters. These valence curves enable each association within the knowledge graph edges to change in positivity and intensity over a specified duration. The shapes of these curves enable characters to possess dynamic affective associations, which may be interpreted to inform character insights including its psychological stability, behaviour, perception, personality, and well-being. Certain characters may exhibit emotional volatility, informed by pronounced fluctuations in valence over a short period, whereas others may display consistency, with strong and enduring curves that exhibit minimal variation over an extended time. A sophisticated character possessing many associations will retain a unique combination of valence curves, each with its own values and rate of change in positivity and intensity. The individuality of each synthetic character is thus defined, with the curve profiles serving as a representation of the stability and intensity of each association. Each character may be predisposed to a certain pattern of valence curves unique to itself, thus distinguishing how different characters feel about similar or shared experiences. An unlimited number of nodes, edges, and valence curves provides infinite opportunity for truly unique characters to be thus designed and represented.

In the context of digital character creation, the application of multiple valence curves to a relationship further allows for the depiction of complex or contradictory emotional states, akin to those experienced by humans or other characters. Common human expressions such as ‘ambivalence’, ‘being of two minds’, or ‘love/hate relationship’ are linguistic approximations of these concurrent valence states, which may simultaneously embody positive and negative emotional aspects. These compound states are represented with greater precision using several dynamic valence scores, enhancing the authenticity of character interactions and emotional depth. A character's decisions are thus informed by the relative intensity of these multiple curves, with the aggregate positivity or negativity of a set of valence scores informing actions.

Employing valence-enabled knowledge graphs as a foundational element for character representation offers numerous avenues for creating detailed portrayals and interactive experiences with synthetic characters. Characters may be generated with robust knowledge graphs containing numerous nodes and edges possessing distinct valence curves. Enabled by this invention, a character's affective associations can be interpreted at a point in time and their likely actions and decisions can be inferred in any scenario that a creative person can imagine. By analyzing specific segments of the network and interpreting semantic relationships alongside valence scores, one can inform the generation of textual and multi-media narratives. This insight will help to craft narratives to facilitate scriptwriting, dynamic human-computer interactions, storytelling, simulations, gameplay, education, and other activities where authentic character representations are advantageous and engaging for human participants.

The present invention may revolutionize the methods by which creative professionals conceptualize and craft character representations. Traditional approaches, where writers and designers construct linear storylines utilizing archetypical characters and traits, are poised to be supplanted by the creation of characters enabled by dynamically changing valence-enabled graph networks. These networks facilitate the definition of complex, multifaceted characters, enabling ongoing interaction with these characters across various temporal spans to generate narrative content. Characters, at specific moments and situations, will exhibit behaviors and reactions that are congruent with their psychological and emotional conditions at that juncture, as well as the significance attributed to relationships with other characters and their situations and environs. The potential for these characters to be incorporated into diverse entertainment and educational offerings is significant, providing a mechanism for the continuous creation of new content. Placed in a plurality of environments and scenarios, the character's actions will remain consistently informed by the associations it makes with these situations.

The present invention's integration with generative artificial intelligence (AI) systems, including large language models, renders the generated textual or numeric outputs particularly pertinent for contemporary applications. These affective insights facilitate the generation of advanced textual prompts that can be incorporated into external systems. These prompts are instrumental in guiding generative AI systems during the creation of multimedia content, encompassing images, videos, spatial environments, virtual reality, or interactive games.

### SUMMARY

In an aspect, the present disclosure provides system for creating digital characters, the system comprising: a knowledge graph interface configured to represent and manage nodes and edges; a valence curve modeller cooperating with the knowledge graph interface, the valence curve modeller configured to model and represent valence curves over a period of time; and, a valence score generator associated with the valence curve modeller, the valence score generator configured to generate and utilize dynamic valence scores derived from the valence curves, wherein the system outputs a representation of the digital characters based on the dynamic valence scores.

In another aspect, the present disclosure provides a method for creating digital characters, the method comprising: creating a series of nodes and edges in a graph network interface; applying a valence curve modeller to model and represent valence curves over a period of time; applying a valence score generator to generate dynamic valence scores derived from the valence curves; and, utilizing a network interrogator to convert the dynamic valence scores into a representation; wherein the representation defines attributes of the digital characters.

### BRIEF DESCRIPTION OF THE DRAWINGS

The following figures serve to illustrate various embodiments of features of the disclosure. These figures are illustrative and are not intended to be limiting.

FIG. 1 is a bloc diagram of a system and method of creating a digital character through the application of dynamic valence scores, according to an embodiment of the present disclosure;

FIG. 2 is a bloc diagram of the technical representation of FIG. 1, according to an embodiment of the present disclosure;

FIG. 3 is a visual representation of a graph network of the system and method of FIG. 1, according to an embodiment of the present disclosure;

FIG. 4A is a visual representation of a 2D valence matrix of the system and method of FIG. 1, according to an embodiment of the present disclosure;

FIG. 4B is a 2D representation of the axes of the valence matrix of FIG. 4A, according to an embodiment of the present disclosure;

FIG. 5A is a graphical representation of valence intensity over time (using square root decline equation) of the system and method of FIG. 1, according to an embodiment of the present disclosure;

FIG. 5B is a graphical representation of valence positivity over time (using dampened sine wave equation) of the system and method of FIG. 1, according to an embodiment of the present disclosure;

FIG. 6 is a graphical representation of a network interrogator converting dynamic valence scores to textual representations of the digital character of the system and method of FIG. 1, using the equations shown in FIGS. 5A and 5B, respectively, according to an embodiment of the present disclosure;

FIG. 7 is a table illustrating various textually represented states of the digital character based on valence scores of the system and method of FIG. 1, according to an embodiment of the present disclosure;

FIG. 8A is a graphical representation of a valence change pattern detector updating valence scores based on pattern change detections at Year 9 in graphs for positivity and intensity over time, of the system and method of FIG. 1, according to an embodiment of the present disclosure;

FIG. 8B is a visual representation of the graph network of the scenario of FIG. 8A, according to an embodiment of the present disclosure;

FIG. 9A is a visual representation of a simple graph network of the system and method of FIG. 1, according to an embodiment of the present disclosure;

FIG. 9B is a visual representation of a more informative graph network comprised of variations in edges and nodes in the form of colour and size, of the system and method of FIG. 1, according to an embodiment of the present disclosure;

FIG. 9C is a visual representation of a complex graph network comprised of further variations in edges and nodes with valence data of the system and method of FIG. 1, according to an embodiment of the present disclosure;

FIG. 10 is a visual representation of a potential user interface of the system and method of FIG. 1, according to an embodiment of the present disclosure; and,

FIG. 11 is a visual representation of a potential user interface of the network interrogator for selecting and summarizing valence scores for a subset of nodes, according to an embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

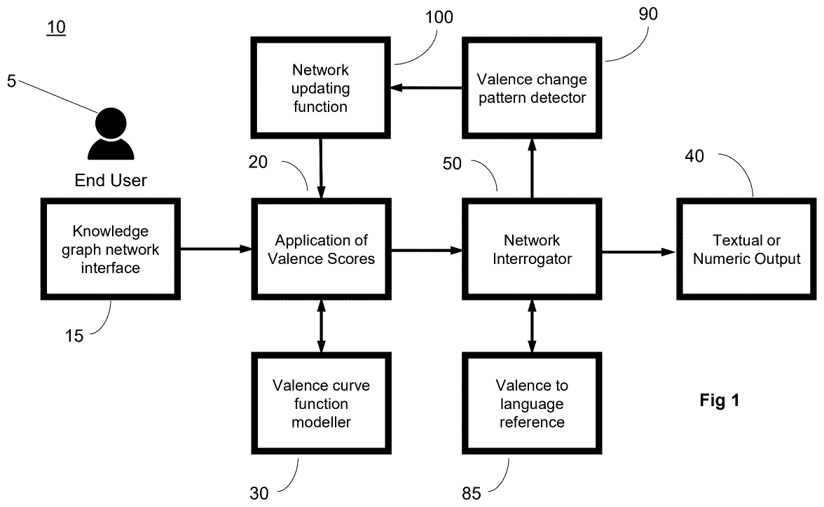

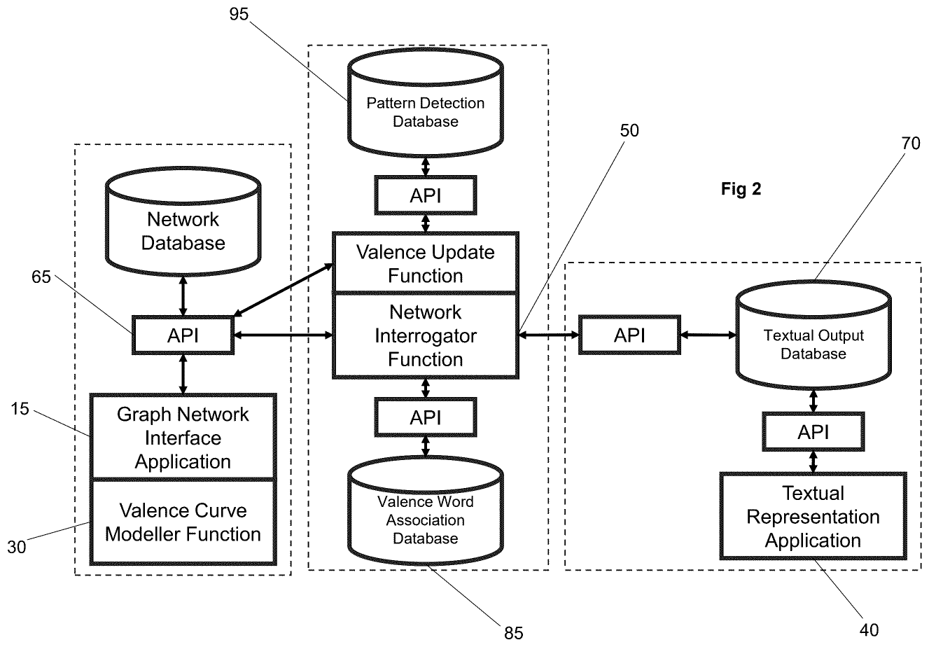

With reference to FIGS. 1 and 2 and according to an embodiment of the present disclosure, a system 10 of creating a digital character through the application of dynamic valence scores is shown. The system 10 is comprised of a knowledge graph network interface 15 configured to manage nodes and edges, a valence score generator 20 configured to generate and utilize valence scores and a valence curve modeller 30 configured to model and represent valence curves over time, wherein the system 10 outputs a textual or numeric representation 40 of the digital characters based on the dynamic valence scores. More particularly, the system 10 is comprised of a user interface (not shown), a graph network building interface 15, and a network node and edge interrogator 50 to build a character and translate its attributes into a textual or numeric representation 40. Biographical attributes assigned to the character are dynamic and can change over time, represented by varied nodes and edges (not shown) in the graph network 15. The relationships between connected nodes are described by edges, with each edge holding a valence score representing the subjective value the character places on that relationship. These valence scores change over time as described by curvilinear values, which may be described by manually drawn or mathematically derived curves such as sinusoidal or sigmoidal curves. The network interrogator 50 queries the network and valence scores to generate a textual or numeric representation of the character's psychological state at a specific point in time. The result is dynamic and realistic representation of a synthetic character's personality over time, for use in at least entertainment and education.

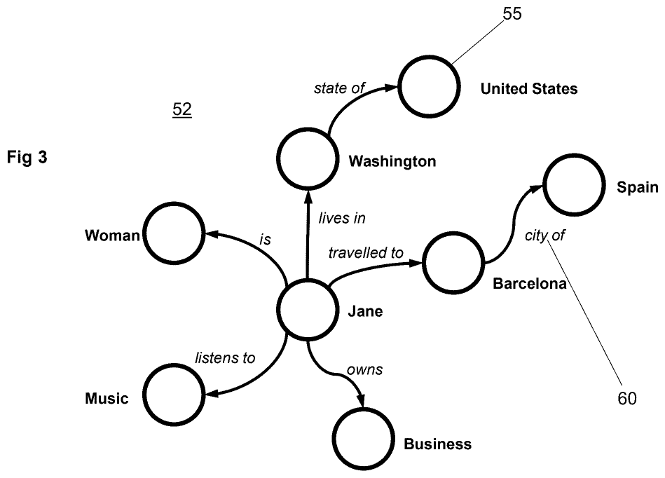

With further reference to FIGS. 1 and 2 and with reference to FIG. 3, the knowledge graph network interface 15 will be described in further detail. The knowledge graph network interface 15 is a software interface, preferably on computer or mobile platform, that presents a suite of operations to create and modify the graph network 52. More particularly, the graph networking interface 15 provides a user 5 with the ability to create nodes 55 and edges 60 in the graph network 52. As shown, each node 55 signifies a specific attribute related to a synthetic character's biographical data. Nodes 55 carry associated metadata elements, typically presented as key/value pairs, to define an attribute's nature and defined value. Meanwhile, the edges 60 act as logical links defining interconnections between nodes 55. The relationships defined by these edges 60 can be objective, subjective, temporal, transactional, or associative. Each edge 60 carries metadata, which includes valence sets indicating ranges of subjective emotions or associations and their correlated intensity. Nodes 55 and edges 60 incorporate metadata indicating the time of their creation, providing a chronological context within the overall timeline of the knowledge graph network interface 15. As shown, the system 10 utilizes Application Programming Interfaces (APIs) 65 to allow third party applications to communication with the knowledge graph network interface 15. Databases 70 are also provided to facilitate data management, indexing, structuring recall, representation, etc. In a preferred but optional embodiment, the system 10 can also be comprised of: a security component (not shown) to ensure data integrity and access control through mechanisms such as user authentication, encryption, or role-based access control; a scalability and performance component (not shown) to ensure the system 10 can handle large-scale graphs 52 efficiently and demonstrates a graceful performance when processing large volumes of data; an interoperability component (not shown) to support data import/export in common formats (e.g. JSON, XML) and provide compatibility with other graph databases or tools; or an error handling and validation component (not shown), to allow the system 10 to manage errors or data inconsistencies, such as circular relationships, orphan nodes, or invalid metadata, ensuring data quality and reliability.

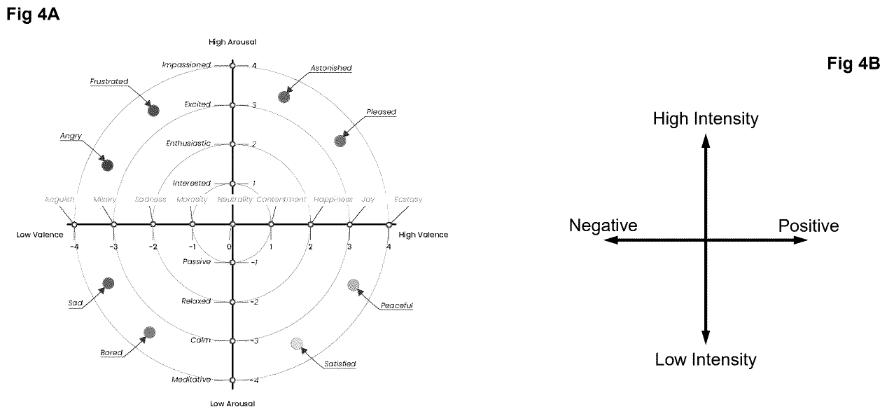

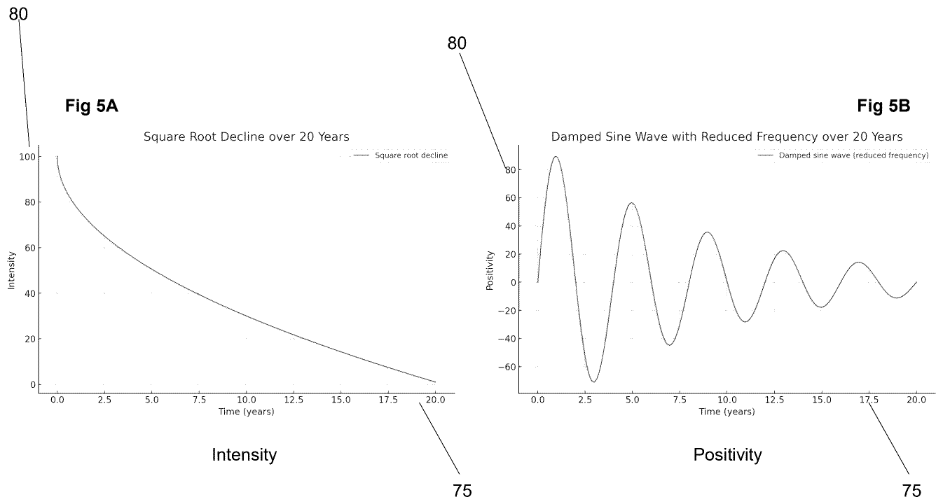

With further reference to FIGS. 1, 2 and 3 and with reference to FIGS. 4A, 4B, 5A and 5B the valence score generator 20 will be described in further detail. The valence score generator 20 primarily revolves around the generation and utilization of valence scores. These scores are derived from the application of sets of two-dimensional curve profiles, as illustrated in FIGS. 5A and 5B. Each of these curve profiles is characterized by two distinct axes: a time-based axis 75 and a value-based axis 80. The time-based axis 75 can represent either a relative or an absolute timeframe and serves as the reference for tracking the progression or duration of an event or experience. The value-based axis 80 is responsible for providing numerical values, which could denote, for example, the intensity or positivity of an experience as changes along the corresponding time axis 75. A visual representation of various valence scores, based on such intensity and positivity, is shown in FIG. 4A. A worker skilled in the art would appreciate that the present embodiment is not limited to a single curve or formula, but rather can use either formula-based curves or manually-defined curves. Indeed, the system 10 allows for a user 5 to interactively and freely draw curves through the knowledge graph network interface 15. This allows for the creation of a curve that can follow any two-dimensional temporal graphical representation and provides flexibility and personalization to the user 5 in defining the valence score patterns. The system 10 also allows for the use of known curves, for example sigmoidal or sinusoidal patterns, which are characterized by their unique rise and fall over the time axis 75. These mathematical functions can either be applied singularly or combined to create customized compound curves. The system 10 provides for visualization support through the user interface. This ensures that users 5 can view, interpret, and adjust the curves as needed. Additionally, to enhance user-friendliness and offer established patterns, there is a provision to select from a library of commonly used curve profiles. These profiles either closely associate with patterns observed in humans or are used for synthetic characters. Users 5 have the flexibility to manually select and apply these profiles, or the system 10 can automatically choose and implement them based on certain criteria or settings.

With further reference to FIGS. 1, 2, 5A and 5B, the valence curve modeller 30 will be described in further detail. The valence curve modeller 30 is an advanced functionality of the system 10 designed to model and represent valence curves. The modeller 30 integrates the manually plotted curves or those defined by formulas to create a comprehensive representation of valence scores. This modeller supports both singular function application and compound curve creation. In a singular function application, a single mathematical function, such as sigmoidal or sinusoidal, is used to define the curve. In compounds curve creation, a user 5 can add or combine multiple mathematical functions or manually drawn curves via the knowledge graph network interface 15. This feature is instrumental in developing intricate and tailored curve profiles that cater to specific needs or scenarios. A user 5 can actively visualize the curves they are working on, making adjustments as required. Furthermore, the modeller 30 is equipped with a library of standard curve profiles. These profiles, which are either reminiscent of human patterns or tailored for synthetic characters, can be manually selected and applied. Alternatively, the system 10 can automate this application process based on predefined parameters or user 5 preferences.

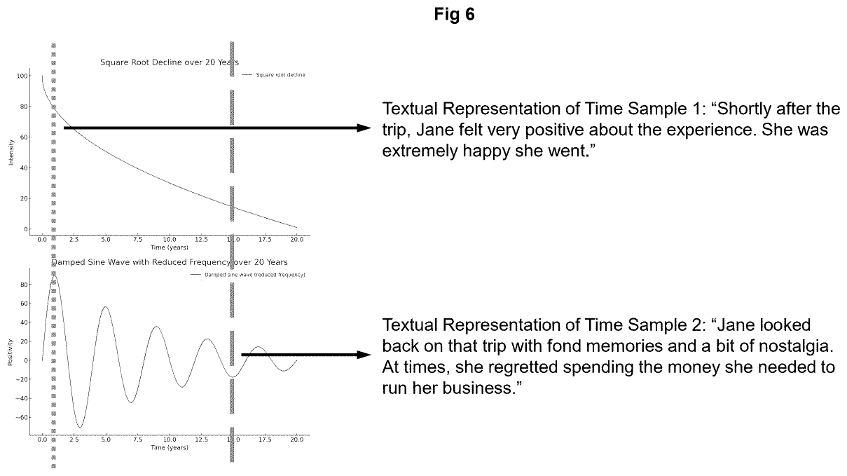

With further reference to FIGS. 1, 2 and 3, and with reference to FIG. 6, the network interrogator 50 will be described in further detail. The network interrogator 50 is designed to examine the graph network 52. The network interrogator 50 encompasses several key functionalities, such as: “selection and loading” where some or all edges and nodes of a network may be selected from the database and loaded into memory, which forms the basis for further examination and processing; or “assessment of relative age” where the age of the edges 60 and nodes 55 is assessed iteratively. Here, the age is calculated from the time of their formation to the relative time of examination. This information is then integrated into the curve formulas to determine the valence scores at any specific moment in time. The valence functions as described in the valence score generator 20 and the valence curve modeller 30 are utilized to calculate and evaluate these scores. The network interrogator 50 also comprises “derivation of subjective feelings” where the system 10 evaluates one or more relationships defined by the network edges 60 and derives the synthetic character's subjective feelings. This adds depth and context to the analysis and representation of a synthetic character. Finally, the network interrogator 50 is comprised of a “concurrent valence evaluation” component, where multiple valence values are evaluated simultaneously, reflecting the complexity of the network and the multifaceted nature of the relationships; and a “proximity-based evaluation” component whereby nodes 55 that share a close relationship on the network, linked by degrees of separation, contribute to the overall evaluation of the synthetic character's perception. This accounts for the intricate connections and relationships within the graph network 52.

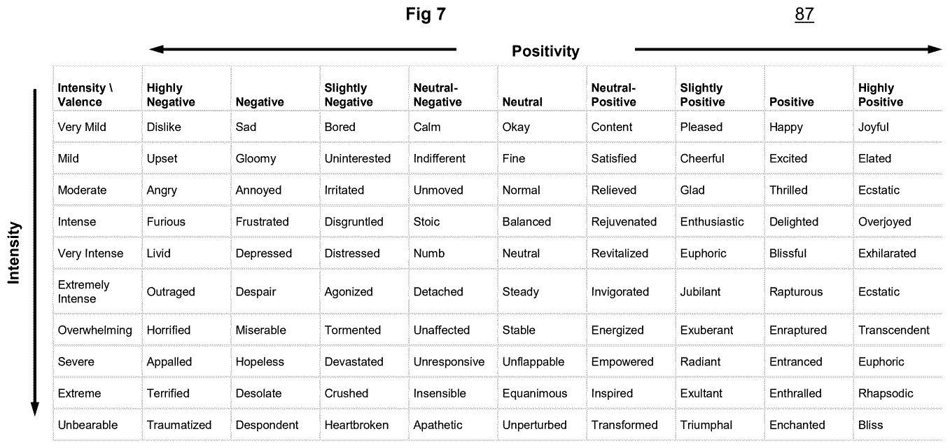

With further reference to FIGS. 1, 2, and 3, and with reference to FIG. 7, the valence to language reference (VLR) component 85 will be described. The VLR component 85 is responsible for valence score pair evaluation, language and textual derivation and multimedia extension. Regarding valence score pair evaluation, each valence score pair is evaluated against an associated table 87 of textual values. This mapping serves to translate the numerical or graphical representation of valence into a language-specific textual reference. Based on the nature of the valence pair and the associated positivity and intensity of the experience, different words or combinations of words are identified. This may include nouns, verbs, adjectives, adverbs, phrases, sentences, or other linguistic elements that appropriately represent the valence pair values. Beyond textual representation, the method may also apply valence scores to other values such as color, image, sound, or combinations of media. This offers a richer and more versatile means of conveying the emotions or experiences captured by the valence scores. Together, the VLR component 85 and the network interrogator 50 enable a comprehensive and nuanced analysis of network relationships and their translation into human-understandable language or multimedia representations. The integration of time, proximity, and valence curves, coupled with the translation into textual or other symbolic forms, provides a powerful tool for understanding, interpreting, and communicating complex network dynamics, particularly in the context of synthetic characters or human-like experiences.

With further reference to FIGS. 1, 2, 3 and 6, the textual or numeric representation 40 will be described in further detail. The textual or numeric representation 40 represents a sophisticated extension of the network interrogator 50. The textual or numeric representation 40 leverages the underlying structure and information within the knowledge graph network interface 15 to produce comprehensive and linguistically coherent textual outputs, such as those shown in FIG. 6. The textual or numeric representation 40 can interpret relationships by utilizing the nodes 55 within the knowledge graph network interface 15 to define biographical facts, and infer feelings associated with relationships between these facts by analyzing edges 60 with valence metadata. The nature of the relationships is further evaluated to define the action taken, transforming abstract relationships into textual descriptions. The textual or numeric representation 40 also utilizes linguistic structure generation to apply common linguistic structures to generate textual output. In an English application, the generated sentences may include Subject(S), Verb (V), Object (0), Compliment (C), Adjective (Adj), Adverb (Adv), Preposition (P), Conjunctions (Conj), and more. A user 5 may define various languages, enabling the generation of outputs in different linguistic structures. Further, based on the nodes 55 selected and relationships identified by the edges 60, the interrogator 50 deduces the Subject and Object. The edge relationship metadata contains verb information, obtained both directly from the nature of the edge 60 and through evaluation of valence scores. The textual representation 50 also identifies several proximally related nodes 55 within the knowledge graph network interface 15, along with their relative age, to establish a preposition. When examining several nodes 55 and edges 60 concurrently, the interrogator 50 may produce conjunctional statements, enabling more complex textual outputs. The textual representation 50 also provides temporal and network proximity analysis by examining nodes 55 in relation to two general schemes: temporal proximity (based on relative creation times) and network proximity (degrees of separation within a network). These proximities are used to define connections, establish narrative context, generate linguistic context, or subject, and produce sentences that convey causality or contextual value. When multiple relationships and valence scores are identified between the same two nodes 55, more intricate textual outputs are produced. The generated textual outputs may be returned immediately from the interrogator 50 or persisted into a database for future use or retrieval. As such, the textual representation 50 represents a significant advancement in the field of network analysis and natural language generation. By intelligently interpreting the knowledge graph network interface 15 and applying linguistic rules, the textual representation 50 can transform abstract relationships and data into meaningful, context-rich narratives or textual descriptions. The versatility of the textual representation 50 across languages and complexity levels makes it a highly valuable tool for a broad spectrum of applications, from storytelling and content creation to data visualization and semantic analysis.

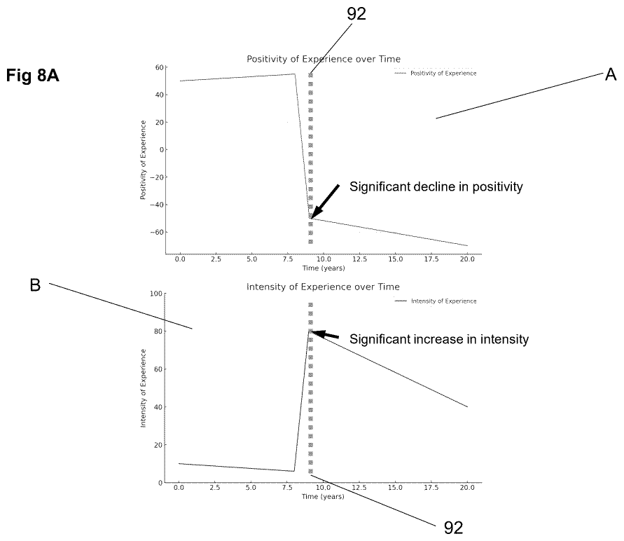

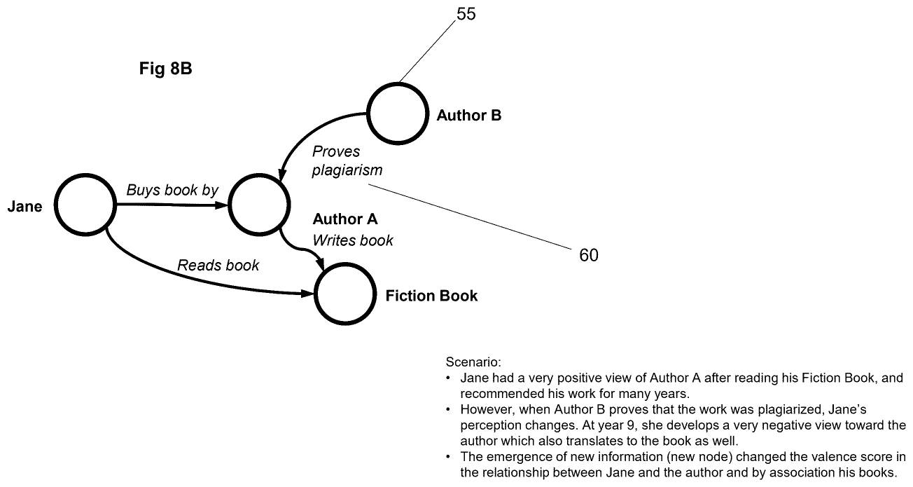

With further reference to FIGS. 1, 2 and 3 and with reference to FIGS. 8A and 8B and according to an embodiment of the present disclosure, an optional valence change pattern detector 90 is described. The valence change pattern detector 90 introduces an advanced capability into the network interrogator 50. This functionality enables the detection of different patterns of valence change 92 by sampling multiple time periods within a synthetic character's network, as shown in positivity over time graph A and intensity over time graph B in FIG. 8A. The valence change pattern detector 90 can detect changes in valence 92, which act as triggers to update other valence scores within the knowledge graph network interface 15. Valence changes 92 may be identified in terms of positivity, intensity, or both, and can be either significant or gradual. For instance, a valence pair's rapid transition from positive to negative sentiment or low to high changes in intensity may signal a significant change in the synthetic character's perspective towards certain relationships. There are numerous types of pattern change, for example patterns of change may be abrupt, marked by a significant shift within a short timeframe, or gradual, characterized by incremental increases or decreases over a longer time horizon. Pattern models are stored in a pattern detection database 95. Similar to the valence curves databases, the pattern detection database 95 contains a collection of valence change patterns over time. Pattern types are used to define a proximate match between the valence score of an edge 60 and the pattern described within the database. Upon detection of these patterns through the sampling of valence scores across different timespans within the synthetic character's history, triggers are produced when patterns cross a user-defined threshold of similarity. These triggers activate the network update function 100, which updates the valence scores of temporally or relationally proximate nodes 55 and edges 60. The valence change pattern detector 90 can work in conjunction with the network update function 100 and modifies the user-defined curves described in the valence curve modeller 30. The pattern-driven updates to the valence scores lead to dynamic and evolving textual representations of the synthetic character, reflecting changes in the character's psychological state over time. Meanwhile, the network update function 100 represents a programmable mechanism that modifies the valence curves of edges 60 within the knowledge graph network interface 15. When edges 60 are identified to change in positivity or intensity, the nature of the change may prompt an update to other associated edges 60 within the knowledge graph network interface 15. This ensures that changes in one part of the graph network 15 reflect and influence other connected elements, maintaining consistency and logical coherence. The updates target temporally or relationally proximate nodes 55 and edges 60, ensuring that changes are contextually relevant and aligned with the underlying knowledge graph network interface 15 structure. The updates contribute to the dynamic nature of the synthetic character's textual representations, allowing them to evolve and change over time. This adds depth, responsiveness, and realism to the generated outputs, enhancing their applicability and relevance in various contexts. Together, the valence change pattern detection 90 and the networking updating function 100 add a new layer of complexity and adaptability to the system 10. They enable the detection and interpretation of valence changes 92 within the knowledge graph network interface 15, leading to responsive updates that reflect the dynamic nature of relationships and feelings. By integrating pattern detection with programmatic updating, the valence change pattern detection 90 and the networking updating function 100 offer a more nuanced and evolving representation of the synthetic character, with potential applications in areas such as virtual reality, storytelling, behavioral modeling, and more. A worker skilled in the art would appreciate that the valence change pattern detection 90 and the networking updating function 100 are optional embodiments, and that the system 10 can still function without these components.

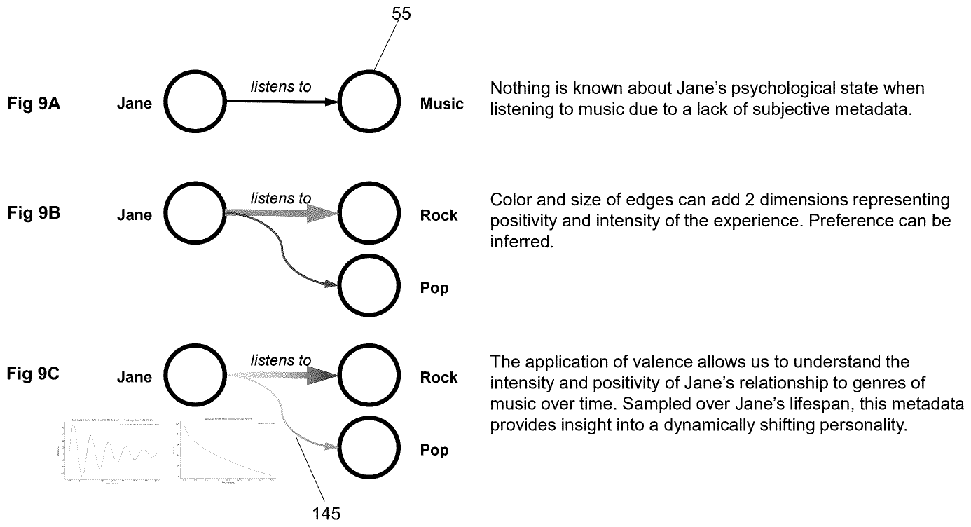

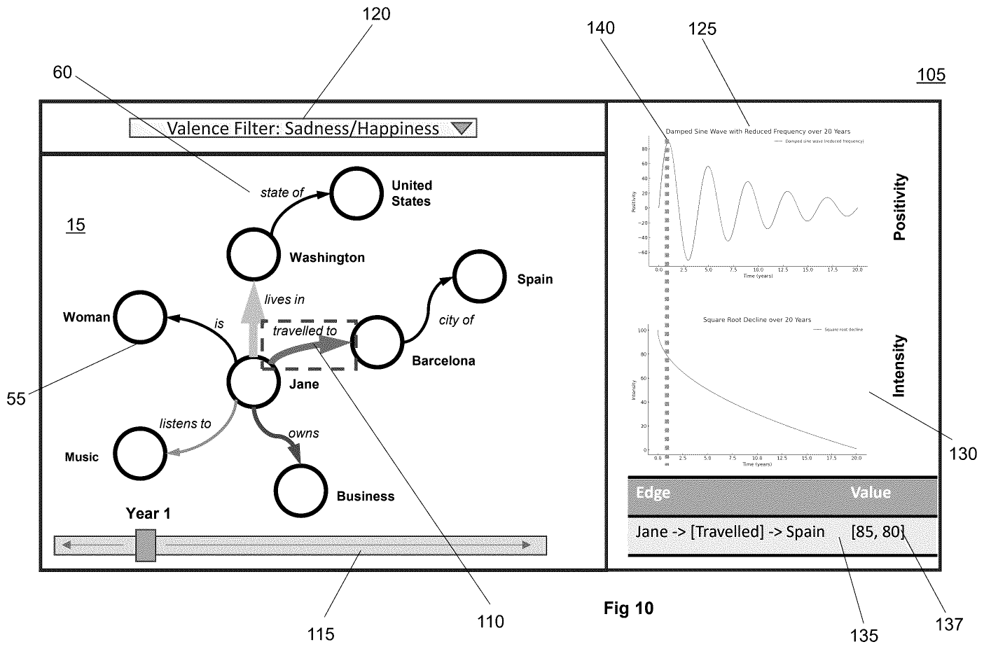

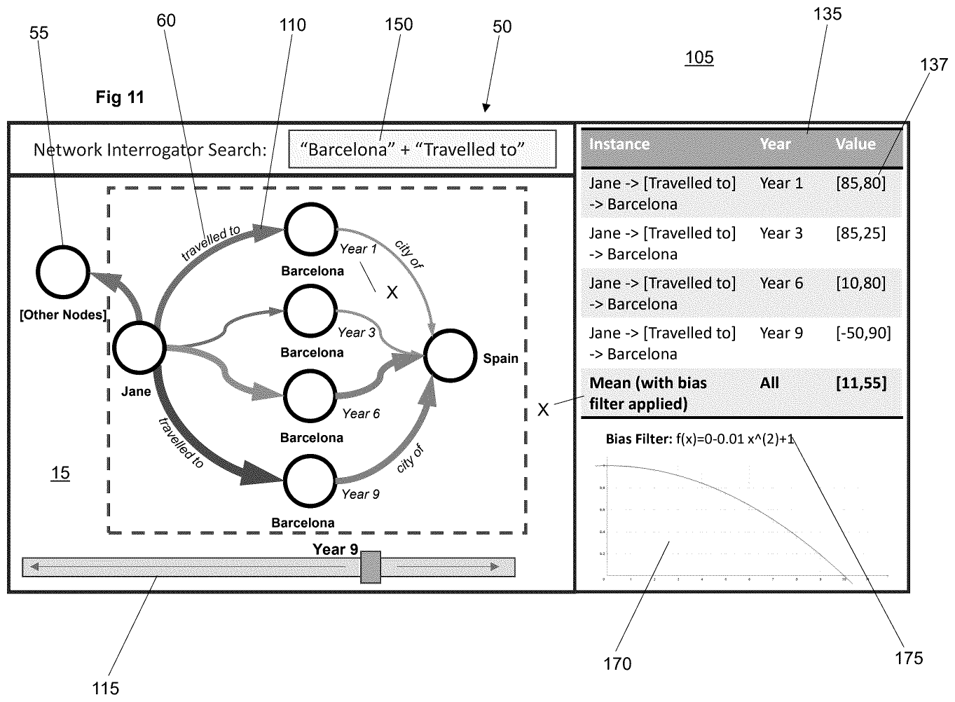

With reference to FIGS. 9A, 9B, 9C and 10 and according to an embodiment of the present disclosure, the knowledge graph network interface 15 may provide for enhanced network edges 145 with valence data such as those shown in FIGS. 9A, 9B and 9C specifically. Meanwhile, FIG. 10 illustrates a visual representation of a portion of a user interface (UI) 105 of the system 10, comprising a knowledge graph network interface 15 using directional arrows 110 indicating the semantic relationship (e.g. Jane travelled to Spain, Spain did not travel to Jane). The UI 105 is also comprised of a navigable timeline 115, valence filters 120 as well as a positivity graph 125 and an intensity graph 130. An optional numerical table 135 is also shown to provide the numeric valence value 137. As shown, the directional arrows 110 have a width and colour scheme to indicate positivity and intensity; however, a worker skilled in the art would appreciate that other means to visually represent these values is possible. During operation, as the user 5 scrubs the timeline, the vertical line 140 on the charts would also animate back and forth and the valence scores in the chart 130 would be animated and reflected on the knowledge graph network interface 15. Additionally, during scrubbing, new nodes 55 would appear and disappear. Simple point-in-time valence can be represented by line width (positivity) and colour (intensity) or other schemes that the user defined, such as those shown in FIGS. 9B and 9C. Logically, synthetic characters, like humans, gain more nodes 55 continually over time, although there is only a subset of items which have noteworthy valence, mapping to our current interests. Scrubbing left to right allows a user 5 to move along the synthetic character's lifespan (youth to old age) and seeing how the network changes.

With reference to FIG. 11 and according to an embodiment of the present disclosure, a visual representation of a portion of the UI 105 of the system 10, specifically comprising a knowledge graph network interface 15 using directional arrows 110. In this embodiment, the network interrogator 50 is shown, the network interrogator 50 having several features. For example, the network interrogator 50 may have a search function 150 to search for specific nodes 55 and edges 60. By way of example, the search function 150 as shown in FIG. 11 contains the key words “Barcelona” (a node 55) and “Travelled to” (an edge 50). Based on the search criteria, the knowledge graph network interface 15 provides a visual representation of the search criteria. In other words, the search function 150 can pull relevant nodes 55 based on their values as well as related set of edges 60 and visually represent this data. In this embodiment, the UI 105 also provides a table 135 that textually and numerically represents the data from the knowledge graph network interface 15. The table 135 also contains valence scores 137, in this represented by positivity and intensity in numeric form. A scrubbable timeline 115 is also provided, that can be used to select a particular time in the life of the character. A filter function 170 is also provided to apply a bias filter 175. In this embodiment, the bias filter 175 enables the modification of the value of specific valence scores 137 relative to the point on the timeline of the character (i.e. Jane). A variety of mathematically or manually created filters 175 could be applied to influence the values of the valence scores 137 relative to their distance (in time) from the moment selected. In the present embodiment, a parabolic filter function is applied to reduce the values associated to events as they approach 10 years down to zero. Thus, this bias filter 175 negates any affective associations beyond 10 years from evaluation, resulting in stronger bias toward more recent experiences. In the illustrated example, the subject character “Jane” travelled four times to Barcelona, each with a varied experience. As shown, the most recent experience was negative. The bias filter 175 adjusts the mean valence Jane experiences toward Barcelona to create greater emphasis on the most recent values, thus adjusting the final score lower. In another embodiment, a different filter may prioritize the opposite effect, with a higher emphasis placed on earlier or initial experiences, for example. Where character's net valence scores 137 would reasonably inform the actions of the character, and the diversity of different valence scores 137 would also inform the creation of a narrative. By way of example not intended to be limiting, the valence scores 137 represented in the table 135 could reasonably be interpreted by a person or system to deduce: “Jane has had four trips to Barcelona, some very positive. However, Jane's most recent trip was quite negative. As a result, Jane's overall opinion today is somewhat neutral. If given the opportunity, Jane would feel ambivalent about another trip to Barcelona”.

With further reference to FIGS. 1 and 10 and according to an embodiment of the present disclosure, a method for creating digital characters is described. In a preferred embodiment, the method is comprised of creating series of nodes 55 and edges 60 in a knowledge graph network interface 15, applying a curve modeller 30, which utilizes a chosen curve to generate dynamic valence scores 137 over a period of time, and utilizing a network interrogator 50 to convert the dynamic valence scores 137 into textual representations (not shown) of a digital character.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A system for creating digital characters, the system comprising:
a knowledge graph interface configured to represent and manage nodes and edges;
a valence curve modeller cooperating with the knowledge graph interface, the valence curve modeller configured to model and represent valence curves over a period of time; and,
a valence score generator associated with the valence curve modeller, the valence score generator configured to generate and utilize dynamic valence scores derived from the valence curves,
wherein the system outputs a representation of the digital characters based on the dynamic valence scores.

2. The system of claim 1 further comprising a network interrogator configured to receive an input and query the system to generate a subset of the nodes and the edges.

3. The system of claim 1 further comprising a valence change pattern detector to detect changes in the valence curves over the period of time.

4. The system of claim 3 further comprising a network update function configured to receive a valence score update input from the valence change pattern detector, the network update function communicating with the valence score generator to update the dynamic valence scores.

5. The system of claim 3 further comprising a remote pattern detection database to store pattern models, the remote pattern detection database in communication with the valence change pattern detector.

6. The system of claim 1 further comprising a valence to language reference (VLR) module, the VLR module configured to analyze and provide an evaluation of relationships between the nodes and the edges.

7. The system of claim 1 wherein the representation is at least one of a textual representation and a numeric representation of the digital characters.

8. The system of claim 1 wherein the representation defines attributes, the attributes representing an affective state of the digital characters at a specified moment and within a specified context.

9. The system of claim 1 wherein the nodes are data points representing various details about the digital character, and wherein the edges form relationships between the data points to illustrate and describe how the data points are related to one another.

10. A method for creating digital characters, the method comprising:
creating a series of nodes and edges in a graph network interface;
applying a valence curve modeller to model and represent valence curves over a period of time;
applying a valence score generator to generate dynamic valence scores derived from the valence curves; and,
utilizing a network interrogator to convert the dynamic valence scores into a representation;
wherein the representation defines attributes of the digital characters.

11. The method of claim 10 wherein the attributes represent an affective state of the digital characters at a specified moment and within a specified context.

12. The method of claim 10 further comprising the step of utilizing a valence change pattern detector to detect changes in the valence curves over the period of time.

13. The method of claim 12 further comprising the step of utilizing a network update function to receive a valence score update input from the t valence change pattern detector, the network update function communicating with the valence score generator to update the dynamic valence scores.

14. The method of claim 12 further comprising the step of communicating with a remote pattern detection database to store and retrieve pattern models.

15. The method of claim 10 further comprising the step of analyzing and providing an evaluation of relationship between the nodes and the edges using a valence to language reference (VLR) module.

16. The method of claim 10 wherein the representation is at least one of a textual representation and a numeric representation of the digital characters.

17. The method of claim 10 wherein the nodes are data points representing various details about the digital characters, and wherein the edges form relationships between the data points to illustrate and describe how the data points are related to one another.
